(19) United States
(12) Patent Application Publication
(10) Pub. No.: US 2026/0005956 A1
(43) Pub. Date: Jan. 1, 2026

(54) AUTOMATIC CLUSTERING-BASED COMMUNICATION NETWORK MANAGEMENT

(71) Applicant: AT&T Intellectual Property I, L.P., Atlanta, GA (US)

(72) Inventors: Alberto Rosas, Mckinney, TX (US); Arjun Coimbatore Nagarasan, Lewisville, TX (US); Anna Mai, Irving, TX (US); Bhargavee Kannikanti, Little Elm, TX (US); Sravan Kumar Kannuri, Richardson, TX (US); Sriram Kothandaraman, Plano, TX (US)

(21) Appl. No.: 18/759,527

(22) Filed: Jun. 28, 2024

(51) Int. Cl. H04L 45/28; H04L 45/125; H04L 45/30

(52) U.S. Cl. CPC H04L 45/28; H04L 45/125; H04L 45/30

(57) ABSTRACT

A processing system may generate vector embeddings from network operational data of a communication network. The processing system may next apply a variational autoencoder to the vector embeddings to create a set of stratified samples, where the set of stratified samples comprises at least a first portion of the plurality of vector embeddings. In addition, the processing system may train a self-organizing map using the stratified samples to create a plurality of clusters. The processing system may next apply the self-organizing map to at least a second portion of the plurality of vector embeddings to assign the at least the second portion to respective clusters of the plurality of clusters. The processing system may then identify at least one characteristic associated with at least one cluster and may perform at least one remedial action in the communication network in response to the identifying of the at least one characteristic.

The present disclosure relates generally to communication network operations and management, and more particularly to methods, computer-readable media, and apparatuses for performing a remedial action in a communication network based on a characteristic associated with a cluster created via a self-organizing map using stratified samples of vector embeddings generated from a set of network operational data, and to methods, computer-readable media, and apparatuses for performing a remedial action in a communication network based on a first vector embedding being assigned to a cluster created via a self-organizing map using stratified samples of vector embeddings generated from a set of network operational data.

### BACKGROUND

Machine learning in computer science is the scientific study and process of creating algorithms based on data that perform a task without any instructions. These algorithms are called models and different types of models can be created based on the type of data that the model takes as input and also based on the type of task (e.g., prediction, classification, clustering) that the model is trying to accomplish. The general approach to machine learning involves using the training data to create the model, testing the model using cross-validation and testing data, and then deploying the model to production to be used by real-world applications

### SUMMARY

In one example, the present disclosure describes a method, computer-readable medium, and apparatus for performing a remedial action in a communication network based on a characteristic associated with a cluster created via a self-organizing map using stratified samples of vector embeddings generated from a set of network operational data. For instance, in one example, a processing system including at least one processor may generate a plurality of vector embeddings from a set of network operational data of a communication network. The processing system may next apply a variational autoencoder to the plurality of vector embeddings to create a set of stratified samples of the plurality of vector embeddings, where the set of stratified samples comprises at least a first portion of the plurality of vector embeddings. In addition, the processing system may train a self-organizing map using the stratified samples of the plurality of vector embeddings to create a plurality of clusters. The processing system may next apply the self-organizing map to at least a second portion of the plurality of vector embeddings to assign vector embeddings of the at least the second portion of the plurality of vector embeddings to respective clusters of the plurality of clusters. The processing system may then identify at least one characteristic associated with at least one cluster of the plurality of clusters and may perform at least one remedial action in the communication network in response to the identifying of the at least one characteristic.

In addition, in one example, the present disclosure describes a method, computer-readable medium, and apparatus for performing a remedial action in a communication network based on a first vector embedding being assigned to a cluster created via a self-organizing map using stratified samples of vector embeddings generated from a set of network operational data. For instance, in one example, a processing system including at least one processor may generate a plurality of vector embeddings from a set of network operational data of a communication network. The processing system may next apply a variational autoencoder to the plurality of vector embeddings to create a set of stratified samples of the plurality of vector embeddings, where the set of stratified samples comprises at least a first portion of the plurality of vector embeddings. In addition, the processing system may train a self-organizing map using the stratified samples of the plurality of vector embeddings to create a plurality of clusters. The processing system may next generate at least a first vector embedding from network operational data associated with at least a first entity and may apply the at least the first vector embedding as an input to the self-organizing map to assign the at least the first vector embedding to a first cluster of the plurality of clusters. The processing system may then perform at least one remedial action in the communication network in response to the at least the first vector embedding being assigned to the first cluster.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example automatic clustering process, in accordance with the present disclosure;

FIG. 3 illustrates a flowchart of an example method for performing a remedial action in a communication network based on a characteristic associated with a cluster created via a self-organizing map using stratified samples of vector embeddings generated from a set of network operational data;

FIG. 4 illustrates a flowchart of an example method for performing a remedial action in a communication network based on a first vector embedding being assigned to a cluster created via a self-organizing map using stratified samples of vector embeddings generated from a set of network operational data; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatuses for performing a remedial action in a communication network based on a characteristic associated with a cluster created via a self-organizing map using stratified samples of vector embeddings generated from a set of network operational data, and methods, non-transitory (i.e., tangible or physical) computer-readable storage media, and apparatuses for performing a remedial action in a communication network based on a first vector embedding being assigned to a cluster created via a self-organizing map using stratified samples of vector embeddings generated from a set of network operational data. In particular, examples of the present disclosure provide fully-automated machine learning-based data clustering, enrichment, governance, and quality control for communication network operations. The overall system remains domain agnostic, with auto-scaling, in-memory capabilities. It is noted that existing clustering algorithms may depend on one or more parameters/hyperparameters to decide the number of clusters to be used. For example, in the k-nearest neighbors (KNN) algorithm, the value k decides the number of nearest neighbors to be included in a majority voting process. This may be problematic insofar as different values of the parameters and hyperparameters may yield different results for the same set of data. Furthermore, this clustering process may be iterated and validated several times before converging to an optimal solution. These multiple iterations increase operational costs.

In contrast, examples of the present disclosure implement automated rules and machine learning models utilizing domain knowledge for record recognition and linkage, allowing for an autonomous, streamlined data clustering. In one example, the present disclosure may include a data preparation phase in which network operational data is collected and normalized, which may include data cleansing and dynamic configurations. In one example, the present disclosure may next generate vector embeddings of the input data via a vector embedding model. For instance, in one example, the vector embedding model may be a component of a large language model (LLM), such as a generative pre-trained transformer (GPT), an ada text embedding model, or the like. In one example, the present disclosure may intelligently sample these vector embeddings to a smaller set representing the entire dataset. For instance, in one example, the present disclosure may implement a variational autoencoder to generate a stratified sampling of the vector embeddings. Subsequently, the reduced set of stratified samples may be used to train a neural network that performs hyperparameter tuning to identify an optimized underlying pattern to segregate the data into distinct clusters. For instance, in one example, the neural network may comprise a self-organizing map (SOM). In one example, the present disclosure provides continuous improvement as new input data is ingested, to provide an updated, holistic view of the network operational data throughout the pipeline.

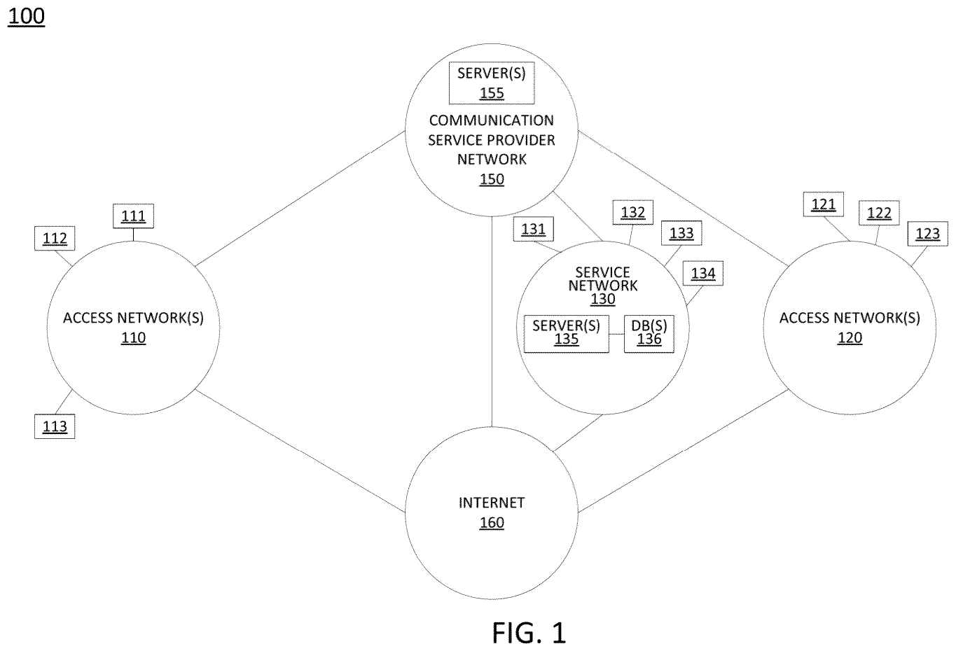

Examples of the present disclosure thus enable automatic remedial action and alerting as new input data is processed via the trained neural network, e.g., via a self-organizing map, and assigned to cluster(s). The end-to-end autonomous clustering may be applied to network operational data across multiple systems, and may be used for process optimization across multiple entities via an intuitive methodology that is collectively applicable for a variety of types of data. Examples of the present disclosure may provide time and costs savings for network troubleshooting and/or root cause identification, as well as remedial actions responsive to various network events and/or conditions detectable via the clustering of the present disclosure. Alternatively, or in addition, examples of the present disclosure may provide a cluster-based organization of unstructured data that may be used for subsequent unsupervised learning, e.g., to troubleshoot network issues or derive network operational insights. In addition, examples of the present disclosure may be agnostic to input data type and may be applicable to all forms of data across various domains and system types. As just one example, the present disclosure may cluster network operational data relating to endpoint device network usage. For instance, endpoint devices, accounts, and/or customers may be clustered based on network utilization patterns and behaviors related to network consumption. The cluster information may then be leveraged to optimize network usage, e.g., by understanding peak usage times, popular services, and other behaviors, thereby enabling a communication network to automatically allocate resources more efficiently and to improve overall network performance. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure may operate. Communication service provider network 150 may comprise a core network with components for telephone services, Internet services, and/or video services (e.g., triple-play services, etc.) that are provided to customers (broadly “subscribers”), and to peer networks. In one example, communication service provider network 150 may combine core network components of a cellular network with components of a triple-play service network. For example, communication service provider network 150 may functionally comprise a fixed-mobile convergence (FMC) network, e.g., an IP Multimedia Subsystem (IMS) network. In addition, communication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Communication service provider network 150 may also further comprise a video broadcast network, e.g., a television broadcast network, such as a cable provider network or an Internet Protocol Television (IPTV) network, as well as an Internet Service Provider (ISP) network. With respect to video service provider functions, communication service provider network 150 may include one or more video servers for the delivery of video content, e.g., a broadcast server, a cable head-end, a video-on-demand (VOD) server, and so forth. For example, communication service provider network 150 may comprise a video super hub office, a video hub office and/or a service office/central office.

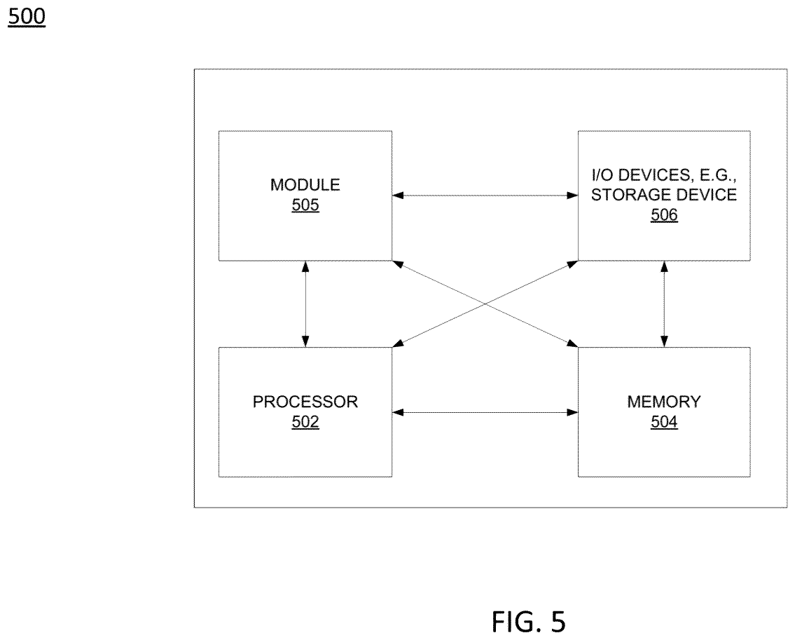

In one example, communication service provider network 150 may also include one or more servers 155. In one example, the servers 155 may each comprise a computing system, such as computing system 500 depicted in FIG. 5, and may be configured to host one or more network-based systems/components in accordance with the present disclosure. For example, a first system component may comprise a database of assigned telephone numbers, a second centralized system component may comprise a database of basic customer account information for all or a portion of the customers/subscribers of the communication service provider network 150, a third centralized system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, an SMS server and/or an MMS server, a voicemail server, a video-on-demand server, a server for network traffic analysis, and so forth. It should be noted that in one example, a system component may be hosted on a single server, while in another example, a system component may be hosted on multiple servers, e.g., in a distributed manner. For ease of illustration, various components of communication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between communication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the communication service provider network 150. Endpoint devices 111-113 and 121-123 may each comprise a telephone, e.g., for analog or digital telephony, a mobile device, such as a cellular smart phone, a laptop, a pair of smart eye glasses or goggles, a tablet computer, etc., a router, a gateway, a desktop computer, a plurality or cluster of such devices, a television (TV), e.g., a “smart” TV, a set-top box (STB), and the like. In one example, any one or more of the endpoint devices 111-113 and 121-123 may represent one or more user devices and/or one or more servers of one or more service providers, such as a social media service provider, an over-the-top (OTT) messaging application service provider, a navigation service provider, an online calendar/scheduling service provider, and so on.

In one example, the access networks 110 and 120 may be different types of access networks. In another example, the access networks 110 and 120 may be the same type of access network. In one example, one or more of the access network(s) 110 and 120 may be operated by the same or a different service provider from a service provider operating the communication service provider network 150. For example, each of the access network(s) 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where communication service provider network 150 may provide service network 130 functions, e.g., of a public land mobile network (PLMN)-universal mobile telecommunications system (UMTS)/General Packet Radio Service (GPRS) core network, or the like. In still another example, access network(s) 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access network(s) 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, an Internet Protocol private branch exchange (IPPBX), and so forth, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the communication service provider network 150. For example, the service network 130 may comprise one or more devices for providing services to subscribers, customers, and/or users. For example, communication service provider network 150 may provide a cloud storage service, web server hosting, and other services. As such, service network 130 may represent aspects of communication service provider network 150 where infrastructure for supporting such services may be deployed. In another example, service network 130 may represent a third-party network, e.g., a network of an entity that provides an automated data clustering, classification, and/or alerting service, in accordance with the present disclosure.

In one example, the service network 130 links one or more devices 131-134 with each other and with Internet 160, communication service provider network 150, devices accessible via such other networks, such as endpoint devices 111-113 and 121-123, and so forth. In one example, devices 131-134 may each comprise a telephone for analog or digital telephony, a mobile device, a cellular smart phone, a pair of smart eye glasses or goggles, a laptop, a tablet computer, a desktop computer, a bank or cluster of such devices, and the like. In an example where the service network 130 is associated with the communication service provider network 150, devices 131-134 of the service network 130 may comprise devices of network personnel, such as customer service agents, sales agents, marketing personnel, or other employees or representatives who are tasked with addressing customer-facing issues and/or personnel for network maintenance, network repair, construction planning, and so forth.

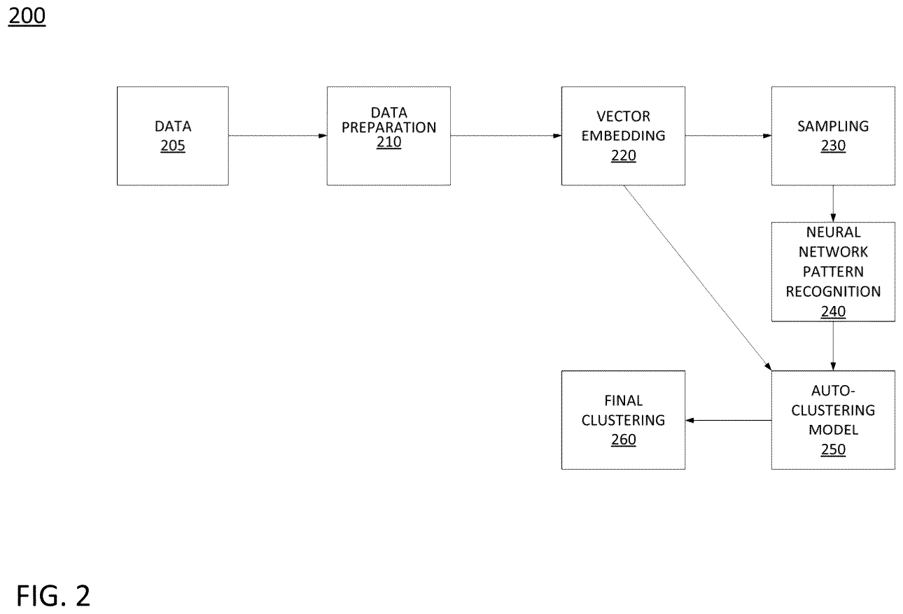

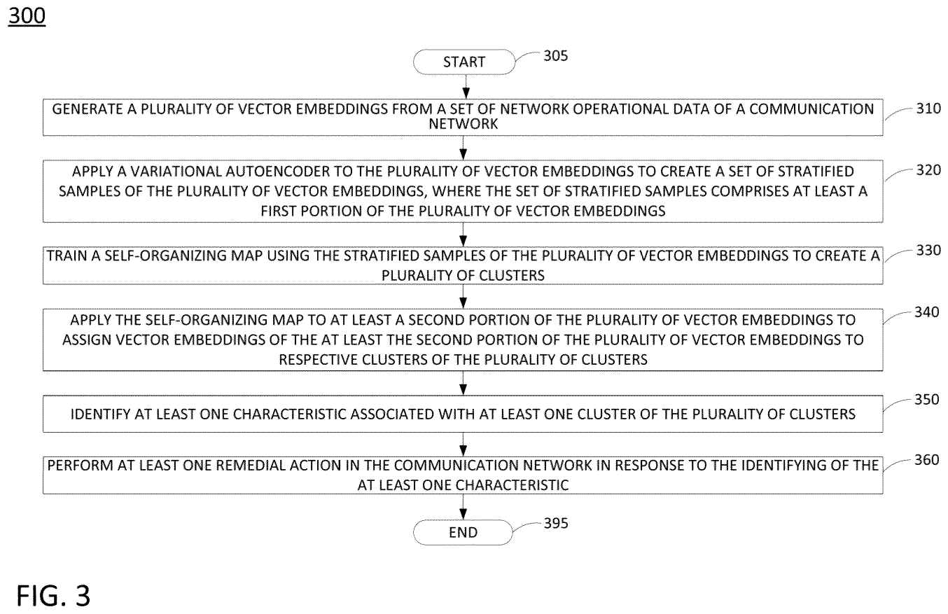

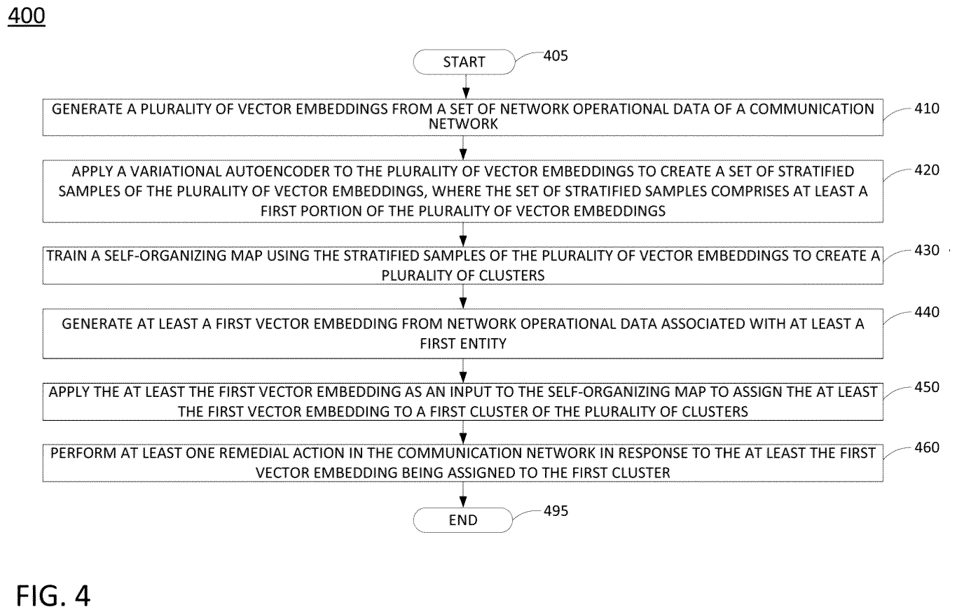

In the example of FIG. 1, service network 130 may include one or more servers 135 which may each comprise all or a portion of a computing device or processing system, such as computing system 500, and/or a hardware processor element 502 as described in connection with FIG. 5 below, specifically configured to perform various steps, functions, and/or operations for performing a remedial action in a communication network based on a characteristic associated with a cluster created via a self-organizing map using stratified samples of vector embeddings generated from a set of network operational data and/or for performing a remedial action in a communication network based on a first vector embedding being assigned to a cluster created via a self-organizing map using stratified samples of vector embeddings generated from a set of network operational data, as described herein. For example, one of the server(s) 135, or a plurality of servers 135 collectively, may perform operations in connection with the example process 200 of FIG. 2, the example method 300 of FIG. 3, and/or the example method 400 of FIG. 4, or as otherwise described herein. In one example, the one or more of the servers 135 may comprise an MLM-based service platform (e.g., a network-based and/or cloud-based service hosted on the hardware of servers 135).

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for performing a remedial action in a communication network based on a characteristic associated with a cluster created via a self-organizing map using stratified samples of vector embeddings generated from a set of network operational data and/or systems for performing a remedial action in a communication network based on a first vector embedding being assigned to a cluster created via a self-organizing map using stratified samples of vector embeddings generated from a set of network operational data, as described herein. As just one example, DB(s) 136 may be configured to receive and store network operational data collected from the communication service provider network 150, such as call logs, mobile device location data, control plane signaling and/or session management messages, data traffic volume records, call detail records (CDRs), error reports, network impairment records, performance logs, alarm data, subscriber/account records, and other information and statistics, which may then be compiled and processed, e.g., normalized, transformed, tagged, etc., and forwarded to DB(s) 136, via one or more of the servers 135.

In one example, DB(s) 136 may be configured to receive and store network operational data in the form of records from customer, user, and/or subscriber interactions, e.g., with customer facing automated systems and/or personnel of a telecommunication network service provider or other entities associated with the service network 130. For instance, DB(s) 136 may maintain call logs and information relating to customer communications which may be handled by customer agents via one or more of the devices 131-134. For instance, the communications may comprise voice calls, online chats, etc., and may be received by customer agents at devices 131-134 from one or more of devices 111-113, 121-123, etc. The records may include the times of such communications, the start and end times and/or durations of such communications, the touchpoints traversed in a customer service flow, results of customer surveys following such communications, any items or services purchased, the number of communications from each user, the type(s) of device(s) from which such communications are initiated, the phone number(s), IP address(es), etc. associated with the customer communications, the issue or issues for which each communication was made, etc.

Alternatively, or in addition, any one or more of the devices 131-134 may comprise an interactive voice response system (IVR) system, a web server providing automated customer service functions to subscribers, etc. In such case, DB(s) 136 may similarly maintain records of customer, user, and/or subscriber interactions with such automated systems. The records may be of the same or a similar nature as any records that may be stored regarding communications that are handled by a live agent. Similarly, any one or more of devices 131-134 may comprise a device deployed at a retail location that may service live/in-person customers. In such case, the one or more of the devices 131-134 may generate records that may be forwarded and stored by DB(s) 136. The records may comprise purchase data, information entered by employees regarding inventory, customer interactions, surveys responses, the nature of customer visits, etc., coupons, promotions, or discounts utilized, and so forth. In still another example, any one or more of the devices 111-113 or 121-123 may comprise a device deployed at a retail location that may service live/in-person customers and that may generate and forward customer interaction records to DB(s) 136.

In one example, DB(s) 136 may alternatively or additionally receive and store data from one or more external data feeds. For instance, DB(s) 136 may receive and store weather data from a device of a third-party, e.g., a weather service, a traffic management service, etc. via one of the access networks 110 or 120. To illustrate, one of endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties, which can then be correlated to network traffic data to reflect impact of various weather conditions on overall network traffic. In still another example, one of the endpoint devices 111-113 or 121-123 may represent a server of a traffic management service (e.g., for vehicular traffic) and may forward various traffic related data to DB(s) 136, such as toll payment data, records of traffic volume estimates, traffic signal timing information, and so forth. Similarly, one of the endpoint devices 111-113 or 121-123 may represent a server of a consumer credit entity (e.g., a credit bureau, a credit card company, etc.), a merchant, or the like. In such an example, DB(s) 136 may obtain one or more data sets/data feeds comprising information such as: consumer credit scores, credit reports, purchasing information and/or credit card payment information, credit card usage location information, and so forth. In one example, aspects of the abovementioned data may be stored in user, subscriber, and/or account profiles, which may include account owner biographic information, such as individual or entity name, address, phone number(s), device identifier(s), authorized users, age(s), service history, payment history, payment methods, communication preferences, privacy preferences, and so forth. In other words, some of the abovementioned data types may be stored in or linked to respective user/account profiles, or the like.

In one example, DB(s) 136 may also store artificial intelligence (AI) models and/or machine learning models (MLMs) that may be trained by, activated, and/or deployed by server(s) 135 in connection with examples of the present disclosure. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. To further illustrate, server(s) 135 and DB(s) 136 may comprise a data feature store and/or artificial intelligence (AI)/machine learning model (MLM) development platform (e.g., a network-based and/or cloud-based service hosted on the hardware of server(s) 135 and/or DB(s) 136). For instance, server(s) 135 may train one or more AI algorithms and/or machine learning model (MLMs) that may be used in examples of the present disclosure.

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like). In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain specific training data.

In one example, MLMs of the present disclosure may include an ML-based generative model, such as a language model, e.g., a “large language model” (LLM). For instance, an ML-based generative model used in the present examples may comprise a generative adversarial network (GAN), a bidirectional encoder representations from transformers (BERT) model (e.g., BERT-Base, BERT-Large, etc.), a generative pre-trained transformer (GPT) model (e.g. GPT, GPT-2, GPT-3, or the like), a GPT sentence embeddings for semantic search (SGPT) model, or other generative natural language processing (NLP) models. In one example, MLMs of the present disclosure may comprise an ada text embedding model. In one example, MLMs of the present disclosure may additionally include a variational autoencoder. In addition in one example, MLMs of the present disclosure may further include a self-organizing map (SOM).

To further illustrate, in one example, one or more of the servers 135 may perform operations such as described in connection with the example method 300 of FIG. 3. For instance, in one example, server(s) 135 may generate vector embeddings from a set of network operational data of communication service provider network 150 (e.g., in one example including network operational data from service network 130, access network(s) 110, and/or access network(s) 120, which, in one example, may be collected and stored in DB(s) 136). In one example, the set of network operational data may be previously collected and normalized, which may include, aggregating, averaging, sampling, smoothing, or other data cleansing operations, etc. Server(s) 135 may next apply a variational autoencoder to the vector embeddings to create a set of stratified samples of the vector embeddings, e.g., where the set of stratified samples comprises at least a first portion of the plurality of vector embeddings. Server(s) 135 may subsequently train a self-organizing map using the stratified samples to create a plurality of clusters and may apply the self-organizing map to at least a second portion of the vector embeddings to assign to respective clusters of the plurality of clusters. Server(s) 135 may then identify at least one characteristic associated with at least one cluster, and may perform at least one remedial action (e.g., in a communication network that may include one or more of the communication service provider network 150, service network 130, access network(s) 110, and/or access network(s) 120) in response to the identifying of the at least one characteristic.

Alternatively, or in addition, one or more of the servers 135 may perform operations such as described in connection with the example method 400 of FIG. 4. For instance, in one example, server(s) 135 may generate vector embeddings from a set of network operational data of communication service provider network 150 (e.g., in one example including network operational data from service network 130, access network(s) 110, and/or access network(s) 120, which in one example, may be collected and stored in DB(s) 136). In one example, the set of network operational data may be previously collected and normalized, which may include, aggregating, averaging, sampling, smoothing, or other data cleansing operations, etc. Server(s) 135 may next apply a variational autoencoder (VAE) to the vector embeddings to create a set of stratified samples of the vector embeddings, e.g., where the set of stratified samples comprises at least a first portion of the plurality of vector embeddings. Server(s) 135 may subsequently train a self-organizing map using the stratified samples to create a plurality of clusters. Next, server(s) 135 may generate at least a first vector embedding from network operational data associated with at least a first entity and apply the at least the first vector embedding as an input to the self-organizing map to assign the at least the first vector embedding to a first cluster of the plurality of clusters. Server(s) 135 may then perform at least one remedial action (e.g., in a communication network that may include one or more of the communication service provider network 150, service network 130, access network(s) 110, and/or access network(s) 120) in response to the at least the first vector embedding being assigned to the first cluster.

Additional operations of server(s) 135 and/or server(s) 135 in conjunction with one or more other devices or systems (such as DB(s) 136) are further described below in connection with the example of FIGS. 2-4. In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in communication service provider network 150, and so forth. Thus, these and other modifications are all contemplated within the scope of the present disclosure.

FIG. 2 illustrates an example auto-clustering process 200, in accordance with the present disclosure. In one example, the process 200 may be performed via a processing system comprising one or more physical devices and/or components thereof, such as a server or a plurality of servers, a database system, and so forth, such as server(s) 135 and/or server(s) 135 in conjunction with DB(s) 136 in FIG. 1. For instance, as shown in FIG. 2, the process 200 may begin at phase 205 with obtaining or selecting a data set, e.g., network operational data or other data associated with various entities (e.g., devices/hardware, systems, users, customers, accounts, network traffic/traffic flows, virtual machines, network slices, network zones, etc.).

At phase 210, the data may be pre-processed for further use. For instance, 210 may include operations such as data cleansing, e.g., including the rectification or removal of data inaccuracies, inconsistencies, or missing values to ensure data reliability and completeness. In one example, 210 may further include data normalization, e.g., adjusting the data values to a common scale without distorting the differences in ranges of values or losing information, making the data suitable for further analysis and/or for use in training or generating outputs of machine learning algorithms, and so forth.

At phase 220, the pre-processed data may be converted to feature vector embeddings, e.g., transforming the raw data into a numerical format understood by machine learning algorithms. In one example, vector embeddings may be generated via a generative embedding model such as a GPT sentence embeddings for semantic search (SGPT) model or an ada text embedding model. These models may map each data point to a high-dimensional space, creating vector embeddings (also referred to as “feature vectors” or “embeddings”), which serve as efficient representations of the data for downstream tasks.

At phase 230, the vector embeddings may be sampled to obtain a reduced set for neural network training at subsequent phase 240. For instance, in one example, a variational autoencoder (VAE) may be used to generate a stratified sample of vector embeddings, e.g., by learning the complex structures within the data. By doing so, the VAE may ensure that each produced sample maintains the original data's distribution, effectively creating a representative sampling across different strata or subgroups in the data.

At phase 240, neural network pattern recognition may be applied to learn clusters from the stratified samples. For instance, phase 240 may include training a self-organizing map (SOM), e.g., a type of artificial neural network. In one example, hyper-parameter tuning may be applied in accordance with a tree of parzens optimizer, such as selecting an initial lattice size, a number of iterations, learning rate(s), convergence threshold(s), a number of reduced dimensions in the map space, the distance function to utilize (e.g., Euclidean, Hamming, Manhattan, Mahalanobis, etc.), and so forth.

At phase 250, the result is a trained auto-clustering model, e.g., a trained self-organizing map, which has been optimized through various iterations until convergence, and in one example through the tuning of hyper-parameters. For instance, a vector embedding may be applied as an input vector to the SOM, which may map such vector embedding to a respective cluster. Accordingly, at phase 260, the trained SOM may be applied or fitted to the full set of vector embeddings. The final output of the process 200 is the auto-clustered data at phase 260. In particular, the data points in data set 200 may be automatically grouped into clusters based on their similarities. This helps in identifying patterns and structures within the data, providing valuable insights for further analysis or decision-making. For instance, accurate predictions or classifications may be made based on the complete auto-clustered data set.

It should be noted that the example process 200 of FIG. 2 is just one example of how an auto-clustering process in accordance with the present disclosure may be implemented. For instance, in another example, phase 250 may be considered as part of phase 240 or the result of phase 240. In one example, data pre-processing may occur via an external system such that phase 210 is removed from (e.g., is performed externally) the process 200. Thus, these and other modifications are all contemplated within the scope of the present disclosure.

FIG. 3 illustrates an example flowchart of a method 300 for performing a remedial action in a communication network based on a characteristic associated with a cluster created via a self-organizing map using stratified samples of vector embeddings generated from a set of network operational data. In one example, steps, functions, and/or operations of the method 300 may be performed by a device as illustrated in FIG. 1, e.g., one of the servers 135. Alternatively, or in addition, the steps, functions and/or operations of the method 300 may be performed by a processing system collectively comprising a plurality of devices as illustrated in FIG. 1 such as one or more of the server(s) 135, DB(s) 136, endpoint devices 111-113 and/or 121-123, devices 131-134, and so forth. In one example, the steps, functions, or operations of method 300 may be performed by a computing device or processing system, such as computing system 500 and/or a hardware processor element 502 as described in connection with FIG. 5 below. For instance, the computing system 500 may represent at least a portion of a platform, a server, a system, and so forth, in accordance with the present disclosure. In one example, the steps, functions, or operations of method 300 may be performed by a processing system comprising a plurality of such computing devices as represented by the computing system 500. For illustrative purposes, the method 300 is described in greater detail below in connection with an example performed by a processing system. The method 300 begins in step 305 and proceeds to step 310.

At step 310, the processing system generates a plurality of vector embeddings from a set of network operational data of a communication network. For instance, in one example, the generating of the plurality of vector embeddings may comprise generating the plurality of vector embeddings via an embedding model. To further illustrate, in one example, the embedding model may comprise a GPT sentence embeddings for semantic search (SGPT) model or an ada text embedding model. In other examples, the embedding model may comprise a word2vec embedding model, a doc2vec embedding model, a davinci embedding model, or other embedding model. In one example, step 310 may comprise creating, via a generative model, generative text synopses for network operational data of the set of network operational data, and applying the generative text synopses as inputs to the embedding model to obtain the plurality of vector embeddings as outputs of the embedding model. For instance, the generative model may comprise a generative pre-trained transformer (GPT) model, a Large Language Model Meta AI (LLAMA) model, a Language Model for Dialogue Applications (LaMDA) model, a Pathways Language Model (PaLM) model, a bidirectional transformer that is pre-trained for language understanding/natural language processing (NLP) tasks (e.g., a Bidirectional Encoder Representations from Transformers (BERT) model).

In one example, the set network operational data may include records associated with different entities, where each vector embedding may be for the network operational data of a single entity. For instance, an entity may comprise an endpoint device or user equipment, a network equipment of the communication network (e.g., a hardware component), such as a router, a switch, a firewall, a line card, an IVR server, a base station, a remote radio head (RRH), a baseband unit (BBU), a power supply, a virtual machine (VM), container, or the like, a plurality of such network components, such as routers within a network zone, data center, or the like, a rack or a set of racks in a data center, etc., one or more virtualized network components, such as a virtual network function (VNF), a set of VNFs, e.g., within a network zone, managed by a same software defined network (SDN) controller, etc., a network slice, and so forth. In one example, an entity may comprise a customer/subscriber, an account, or the like. In still another example, an entity may comprise a traffic flow, e.g., where clusters may be for characterizing different traffic flows, and so forth. In one example, the network operational data may be for a single type of entity, e.g., network routers. In another example, the network operational data may be for a larger category of entities, e.g., communication network equipment, access network equipment, core network equipment, power components, etc.

In one example, the network operational data may comprise one or more of network traffic data, e.g., Domain Name System (DNS) records, call detail record (CDR) data, e.g., CDRs or one or more selected CDR fields (such as a connection time, a session duration, a data volume, a throughput measure, an error flag, etc.), and so forth. In one example, the network operational data may alternatively or additionally comprise at least one record of at least one customer interaction with at least one of: a customer service representative, a salesperson, an interactive voice response (IVR) system, an online automated ordering system, or an online subscriber account system. To further illustrate, the at least one record of the at least one customer interaction may include: a complaint regarding a phone number, subscriber identity module (SIM), account, or the like. Network operational data may alternatively or additionally include network element status information, such as: configuration parameters/settings (e.g., antenna tilt, beamwidth, transmit power, compute resources allocated to a VM (e.g., max processor availability, max memory allocated to the VM, etc.), a class/quality label assigned to a device, customer, customer premises, and/or particular traffic thereof, etc.), and so forth.

In various examples, the network traffic data and/or network element status information may further include network measurements and/or computed performance indicators (e.g., “key performance indicators” (KPIs)), such as peak and average processor utilization, average memory utilization, bandwidth utilization, or the like, packet loss rate, call failure rate, call drop rate, packet delay, packet throughput, jitter, signal to noise (SNR) ratio on various wireless channels, e.g., between UEs and base stations/cell sites, device temperatures of various network elements, other alarm data, and so forth. In one example, the network traffic data and/or network element status information may alternatively or additionally include network performance data sets associated with a video communication session, such as measurements of a video uplink data rate and/or measurements of a video downlink data rate, video multi-method assessment fusion (VMAF) metrics, and so forth. In one example, at least a portion of the set of network operational data may comprise string data, e.g., text or other. For instance, in one example, the set of network operational data may include transcripts of customer interactions, such as customer descriptions of network problems or other service problems, and so forth. In one example, as noted above, other network operational data may be used as input data to a generative model, e.g., to generate a text synopsis. In one example, text synopses may therefore be considered part of the network operational data.

At step 320, the processing system applies a variational autoencoder to the plurality of vector embeddings to create a set of stratified samples of the plurality of vector embeddings, e.g., where the set of stratified samples comprises at least a first portion of the plurality of vector embeddings (broadly a sampling of the plurality of vector embeddings). In one example, the set of stratified samples preserves a threshold percentage of a dimensionality of the set of network operational data. For instance, in one example, dimensionality may be defined as or may correspond to a number of columns of data. However, some columns may be highly correlated with or may be entirely subsumed by data of another column. To illustrate, a date column may have a format of month: day: year, while a timestamp column may have a format of month: day: year: hour: minute. In one example, the preservation of dimensionality may be specified by a user, or a user may provide guidelines on a minimum acceptable loss of dimensionality, in which case the processing system may tune the VAE accordingly.

At step 330, the processing system trains a self-organizing map (SOM) using the stratified samples of the plurality of vector embeddings to create a plurality of clusters. For instance, the SOM may map input vectors in an input space to nodes/neurons (e.g., points/vectors) in a reduced dimensional map space. In one example, each map node may be assigned a weight vector that indicates a corresponding position of the node in the input space, and where the weight vectors are adjusted on an ongoing basis to better fit to the input vectors. In one example, the SOM may be trained in accordance with a tree of Parzens optimizer (or tree-structured Parzen estimator (TPE)), e.g., to perform hyper-parameter tuning, such as selecting an initial lattice size, a number of iterations, learning rate(s), convergence threshold(s), a number of reduced dimensions in the map space, the distance function to utilize (e.g., Euclidean, Hamming, Manhattan, Mahalanobis, etc.), and so forth.

At step 340, the processing system applies the SOM to at least a second portion of the plurality of vector embeddings to assign vector embeddings of the at least the second portion of the plurality of vector embeddings to respective clusters of the plurality of clusters. For instance, the first portion of vector embeddings (from the stratified sampling of step 320) may be used for faster SOM training and cluster identification. Then, the remaining vector embeddings may be assigned at step 340 to the clusters created via the SOM in step 330. For example, each of the second plurality of vector embeddings may be assigned to a respective cluster based upon a distance metric within a vector embedding space, e.g., a Euclidean distance, a Manhattan distance, a Mahalanobis distance, etc.

At step 350, the processing system identifies at least one characteristic associated with at least one cluster of the plurality of clusters. For instance, the at least one characteristic may comprise one or more of: a category of the at least one cluster, a number of vector embeddings assigned to the at least one cluster, a geographic location associated with at least a portion of the vector embeddings assigned to the at least one cluster, a traffic volume associated with the vector embeddings assigned to the at least one cluster, and so forth. For example, the cluster can be an outlier because of the small number within the cluster compared to other clusters, or can be significant when a number becomes large, e.g., indicating a large number of malfunctioning Internet of Things (IoT) devices, a surge in demand for a particular content, a geographic clustering, e.g., of endpoint devices, etc.

Similarly, a geographic location can indicate where a remedial action is to be applied at subsequent step 360, e.g., increased or decreased demand in geographic area. For instance, a cluster may include endpoint devices, network equipment, etc. that are not necessarily geographically confined. Thus, within such as a cluster/group, the member vector embeddings (or the entities associated with the respective network operational data records upon which the assigned member vector embeddings are derived) may be explored to find that more than a threshold number are within a particular geofence, whereupon a remedial action can then be implemented for that location/area/geofence (and for any other areas having greater than a threshold number within the cluster, for example). In one example, a cluster may have a category that may be labeled manually or that may be labeled automatically. For instance, vector embeddings may be associated with previously labeled instances, e.g., UEs, user accounts, traffic records, etc. For instance, for malicious network activity detection, network operational data and/or vector embeddings can be labeled as normal, malicious, etc. Depending upon the particular use case, other examples may include labels such as malfunctioning IoT, spam/no spam, DNS attack, DOS attack, fraud/no fraud, etc.

At step 360, the processing system performs at least one remedial action in the communication network in response to the identifying of the at least one characteristic. For instance, in one example, the at least one remedial action may comprise generating a notification to at least one of: an endpoint device associated with a user of the communication network, a user account associated with the communication network (e.g., a subscriber endpoint device, a phone number, an email address, a username, etc., a workstation of fraud monitoring personnel, network operations personnel, and so forth), or an automated system within the communication network (e.g., a self-optimizing network (SON) orchestrator and/or SDN controller, a firewall, a load balancer, a base station, etc.). To further illustrate, the notification can be an alert, a warning, just the data, or instructions, e.g., to perform further action(s), such as reconfiguring a RAN (including adjusting tilt, azimuth, beamwidth, transmit power, bearer allocations, etc.), blocking traffic, re-routing traffic, rate-limiting traffic, instantiating/activating or deactivating network elements (e.g., VMs, SDN components, or hardware devices, e.g., routers, antenna elements, baseband units, content distribution network (CDN) nodes, etc.), caching content, and so on.

Alternatively, or in addition, the at least one remedial action may include blocking network traffic in the communication network, re-routing network traffic, assigning network traffic to a particular class, reducing throughput of the network traffic in the communication network, or the like. For instance, the network traffic may comprise calls, text messages, video content, etc., which may be visible to the processing system and/or the communication network or which may be encrypted, tunneled, etc. To further illustrate, with respect to assigning network traffic to a particular class, if a cluster is labeled or otherwise associated with malicious network activity, network traffic for endpoint devices subsequently assigned to the cluster may be labeled/assigned as potential malicious traffic, which may have differentiated processing via other elements of the communication network (e.g., re-routing, reduced priority, etc.). In one example, the at least one remedial action may include: reconfiguring at least one aspect of a radio access network portion of the communication network (e.g., tilt, azimuth, beamwidth, power, bearers, etc.), instantiating a virtual network function (VNF), activating a VNF, deactivating a VNF, etc.

Following step 360, the method 300 ends in step 395. It should be noted that method 300 may be expanded to include additional steps, or may be modified to replace steps with different steps, to combine steps, to omit steps, to perform steps in a different order, and so forth. For instance, in one example, the processing system may repeat one or more steps of the method 300, such as steps 310-340 or steps 310-360 for new network operational data and/or a new set of network operational data over a sliding time window (which may partially overlap with the network operational data of a preceding iteration of the steps of the method 300), and so on. In one example, at step 310 the network operational data may be supplemented with other data, such as 3^{rd} party credit card usage data, weather data, etc., where combined records associated with various entities may be used to generate the respective vector embeddings. In one example, the method 300 may include an additional step or steps of data pre-processing, such as described above in connection with phase 210 of the example process 200 of FIG. 2. In another example, the method 300 may be modified or extended to include clustering of other types of data and/or with respect to other types of entities. For instance, in another example, the method 300 may include customer profile clustering for selecting new coverage area or areas of increased network coverage (e.g., cellular access network coverage, broadband fiber access network coverage, etc.). For example, customer profile clustering may result in clusters at step 340 based on shared attributes or behaviors, creating a comprehensive understanding of different customer types at step 350. This information can then be used to recommend at step 360 new or expanded coverage areas, effectively identifying regions where similar potential customers may be located and where the company's services could be expanded or improved. In still another example, the method 300 may include customer segmentation for targeted marketing. For instance, a network operator or other organizing entities may obtain at step 340 customer segments, e.g., groups/clusters of customers sharing similar characteristics or behaviors. This segmentation allows for targeted marketing at step 360, where each group receives marketing messages specifically tailored to their interests, needs, or habits (e.g., which may be identified at step 350) enhancing the effectiveness of the company's marketing efforts. In one example, the method 300 may be expanded or modified to include steps, functions, and/or operations, or other features described above in connection with the example(s) of FIGS. 1, 2, and/or 4, or as described elsewhere herein. Thus, these and other modifications are all contemplated within the scope of the present disclosure.

FIG. 4 illustrates an example flowchart of a method 400 for performing a remedial action in a communication network based on a first vector embedding being assigned to a cluster created via a self-organizing map using stratified samples of vector embeddings generated from a set of network operational data. In one example, steps, functions, and/or operations of the method 400 may be performed by a device as illustrated in FIG. 1, e.g., one of the servers 135. Alternatively, or in addition, the steps, functions and/or operations of the method 400 may be performed by a processing system collectively comprising a plurality of devices as illustrated in FIG. 1 such as one or more of the server(s) 135, DB(s) 136, endpoint devices 111-113 and/or 121-123, devices 131-134, and so forth. In one example, the steps, functions, or operations of method 400 may be performed by a computing device or processing system, such as computing system 500 and/or a hardware processor element 502 as described in connection with FIG. 5 below. For instance, the computing system 500 may represent at least a portion of a platform, a server, a system, and so forth, in accordance with the present disclosure. In one example, the steps, functions, or operations of method 400 may be performed by a processing system comprising a plurality of such computing devices as represented by the computing system 500. For illustrative purposes, the method 400 is described in greater detail below in connection with an example performed by a processing system. The method 400 begins in step 405 and proceeds to step 410.

At step 410, the processing system generates a plurality of vector embeddings from a set of network operational data of a communication network. For instance, in one example, the generating of the plurality of vector embeddings may comprise generating the plurality of vector embeddings via an embedding model, e.g., an SGPT model or an ada text embedding model. In other examples, the embedding model may comprise a word2vec embedding model, a doc2vec embedding model, a davinci embedding model, or other embedding model. In one example, step 410 may comprise creating, via a generative model, generative text synopses for network operational data of the set of network operational data, and applying the generative text synopses as inputs to the embedding model to obtain the plurality of vector embeddings as outputs of the embedding model. For instance, the generative model may comprise a GPT model, a LLaMA model, a LaMDA model, a PaLM model, a BERT model, or the like.

In one example, the network operational data may comprise one or more of: network traffic data, e.g., CDR data or the like. In one example, the network operational data may comprise at least one record of at least one customer interaction with at least one of: a customer service representative, a salesperson, an IVR system, an online automated ordering system, or an online subscriber account system. In one example, the network operational data may comprise network element status information, which may include network measurements and/or computed performance indicators including for video communication sessions. In one example, at least a portion of the set of network operational data may comprise string data, e.g., text or other. In one example, step 410 may comprise the same or similar operations as described above in connection with step 310 of the example method 300 of FIG. 3.

At step 420, the processing system applies a variational autoencoder to the plurality of vector embeddings to create a set of stratified samples of the plurality of vector embeddings, where the set of stratified samples comprises at least a first portion of the plurality of vector embeddings (broadly a sampling of the plurality of vector embeddings). In one example, the set of stratified samples may preserve a threshold percentage of a dimensionality of the set of network operational data. In one example, step 420 may comprise the same or similar operations as described above in connection with step 320 of the example method 300 of FIG. 3.

At step 430, the processing system trains a self-organizing map (SOM) using the stratified samples of the plurality of vector embeddings to create a plurality of clusters. For instance, in one example, the SOM may be trained in accordance with a tree of parzens optimizer. In one example, step 430 may comprise the same or similar operations as described above in connection with step 330 of the example method 300 of FIG. 3.

At step 440, the processing system generates at least a first vector embedding from network operational data associated with at least a first entity. For instance, step 440 may comprise the same or similar operations as step 410, but with respect to a limited set or sets of network operational data associated with the at least the first entity. The at least the first entity may comprise, for example, an endpoint device or user equipment, a network equipment of the communication network (e.g., a hardware component), such as a router, a switch, a firewall, a line card, an IVR server, a base station, a remote radio head (RRH), a baseband unit (BBU), a power supply, a virtual machine (VM), container, or the like, a plurality of such network components, such as routers within a network zone, data center, or the like, a rack or set of racks in a data center, etc., one or more virtualized network components, such as a virtual network function (VNF), a set of VNFs, e.g., within a network zone, managed by a same SDN controller, etc., a network slice, and so forth. In still another example, an entity may comprise a customer/subscriber, an account, or the like. In still another example, an entity may comprise a traffic flow, e.g., where clusters may be for characterizing different traffic flows, and so forth.

At step 450, the processing system applies the at least the first vector embedding as an input to the self-organizing map to assign the at least the first vector embedding to a first cluster of the plurality of clusters. For example, the at least the first vector embedding may be assigned to a respective cluster based upon a distance metric within a vector embedding space, e.g., a Euclidean distance, a Manhattan distance, a Mahalanobis distance, etc. For instance, the first vector embedding may be assigned to the first cluster when the first cluster is closest according to the distance metric as compared to other clusters of the plurality of clusters.

At step 460, the processing system performs at least one remedial action in the communication network in response to the at least the first vector embedding being assigned to the first cluster. For instance, the first cluster may have various characteristics, such as a category/label of the first cluster, a number of vector embeddings assigned to the first cluster, a geographic location associated with at least a portion of the vector embeddings (or the network traffic data records or associated entities) assigned to the first cluster, a traffic volume associated with the vector embeddings assigned to the first cluster, and so forth. In one example, the at least one remedial action may be associated with the at least one characteristic. For instance, if the cluster has a label of “malfunctioning IoT” then the vector embeddings/network operational data records assigned to the first cluster may be for malfunctioning IoT devices. Accordingly, when the first vector embedding from network operational data associated with the first entity is assigned to the first cluster, then the first entity may also be identified as a “malfunctioning IoT.” In addition, an appropriate remedial action may then be taken on this basis. For instance, this may comprise transmitting a notification to a designated contact number, email address, or the like that an IoT device or system is detected within the communication network as being malfunctioning.

In a similar manner, in various examples the at least one remedial action may comprise generating a notification to at least one of: an endpoint device associated with a user of the communication network, a user account associated with the communication network (e.g., a subscriber endpoint device, phone number, email address, username, etc.), a workstation of fraud monitoring personnel, network operations personnel, and so forth, or an automated system within the communication network (e.g., a SON orchestrator and/or SDN controller, a firewall, a load balancer, a base station, etc.). To further illustrate, the notification can be an alert, a warning, the raw data, and/or instructions, e.g., to perform further action(s), such as reconfiguring a radio access network (RAN) (including adjusting tilt, azimuth, beamwidth, transmit power, bearer allocations, etc.), blocking traffic, re-routing traffic, rate-limiting traffic, instantiating/activating or deactivating network elements (e.g., VMs, SDN components, or hardware devices, e.g., routers, antenna elements, baseband units, CDN nodes, etc.), caching content, and so on. Alternatively, or in addition, the at least one remedial action may include blocking network traffic in the communication network for the at least the first entity, re-routing network traffic of the at least the first entity, assigning network traffic for the at least the first entity to a particular class, reducing throughput of the network traffic for the at least the first entity in the communication network, or the like. In one example, the at least one remedial action may include: reconfiguring at least one aspect of a radio access network portion of the communication network (e.g., tilt, azimuth, beamwidth, power, bearers, etc.), instantiating a virtual network function (VNF), activating a VNF, deactivating a VNF, etc.

Following step 460, the method 400 ends in step 495. It should be noted that method 400 may be expanded to include additional steps, or may be modified to replace steps with different steps, to combine steps, to omit steps, to perform steps in a different order, and so forth. For instance, in one example, the processing system may repeat one or more steps of the method 400, such as steps 410-430 or steps 410-460 for a new set of network operational data and/or a new set of network operational data over a sliding time window (which may partially overlap with the network operational data of a preceding iteration of the steps of the method 400), steps 440-460 for additional entities, and so on. In one example, at step 410 the network operational data may be supplemented with other data, such as 3^{rd} party credit card usage data, weather data, etc., where combined records associated with various entities may be used to generate the respective vector embeddings. In one example, the method 400 may include an additional step or steps of data pre-processing, such as described above in connection with phase 210 of the example process 200 of FIG. 2. In another example, the method 400 may be modified or extended to include clustering of other types of data and/or with respect to other types of entities, such as customer profile clustering for selecting new coverage area or areas of increased network coverage, customer segmentation for targeted marketing, and so forth. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the example method 300 or the example method 400 may include a storing, displaying, and/or outputting step as required for a particular application. In other words, any data, records, fields, and/or intermediate results discussed in the method 300 or the method 400 can be stored, displayed and/or outputted either on the device(s) executing the method 300 and/or the method 400, or to another device or devices, as required for a particular application. Furthermore, steps, blocks, functions, or operations in FIGS. 3 and 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 or method 400 may comprise optional steps, or can be combined, separated, and/or performed in a different order from that described above, without departing from the examples of the present disclosure.

FIG. 5 depicts a high-level block diagram of a computing system 500 (e.g., a computing device, or processing system) specifically programmed to perform the functions described herein. For example, any one or more components or devices illustrated in FIG. 1, or described in connection with the process 200 of FIG. 2, the method 300 of FIG. 3, or the method 400 of FIG. 4 may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where hardware processor element may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for performing a remedial action in a communication network based on a characteristic associated with a cluster created via a self-organizing map using stratified samples of vector embeddings generated from a set of network operational data and/or for performing a remedial action in a communication network based on a first vector embedding being assigned to a cluster created via a self-organizing map using stratified samples of vector embeddings generated from a set of network operational data, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 502 is shown, it should be noted that the computing device may employ a plurality of hardware processor elements. Furthermore, although only one computing device is shown in FIG. 5, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 5 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for performing a remedial action in a communication network based on a characteristic associated with a cluster created via a self-organizing map using stratified samples of vector embeddings generated from a set of network operational data and/or for performing a remedial action in a communication network based on a first vector embedding being assigned to a cluster created via a self-organizing map using stratified samples of vector embeddings generated from a set of network operational data (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for performing a remedial action in a communication network based on a characteristic associated with a cluster created via a self-organizing map using stratified samples of vector embeddings generated from a set of network operational data and/or for performing a remedial action in a communication network based on a first vector embedding being assigned to a cluster created via a self-organizing map using stratified samples of vector embeddings generated from a set of network operational data (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
generating, by a processing system including at least one processor, a plurality of vector embeddings from a set of network operational data of a communication network;
applying, by the processing system, a variational autoencoder to the plurality of vector embeddings to create a set of stratified samples of the plurality of vector embeddings, wherein the set of stratified samples comprises at least a first portion of the plurality of vector embeddings;
training, by the processing system, a self-organizing map using the stratified samples of the plurality of vector embeddings to create a plurality of clusters;
applying, by the processing system, the self-organizing map to at least a second portion of the plurality of vector embeddings to assign vector embeddings of the at least the second portion of the plurality of vector embeddings to respective clusters of the plurality of clusters;
identifying, by the processing system, at least one characteristic associated with at least one cluster of the plurality of clusters; and
performing, by the processing system, at least one remedial action in the communication network in response to the identifying of the at least one characteristic.

2. The method of claim 1, wherein the generating of the plurality of vector embeddings comprise generating the plurality of vector embeddings via an embedding model.

3. The method of claim 2, wherein the embedding model comprises:
a generative pre-trained transformer sentence embeddings for semantic search model; or
an ada text embedding model.

4. The method of claim 2, wherein the generating of the plurality of vector embeddings comprises:
creating, via a generative model, generative text synopses for network operational data of the set of network operational data; and
applying the generative text synopses as inputs to the embedding model to obtain the plurality of vector embeddings as outputs of the embedding model.

5. The method of claim 4, wherein the generative model comprises a large language model.

6. The method of claim 1, wherein at least a portion of the set of network operational data comprises string data.

7. The method of claim 1, wherein the set of stratified samples preserves a threshold percentage of a dimensionality of the set of network operational data.

8. The method of claim 1, wherein the self-organizing map is trained in accordance with a tree of parzens optimizer.

9. The method of claim 1, wherein the at least one characteristic comprises:
a category of the at least one cluster;
a number of vector embeddings assigned to the at least one cluster;
a geographic location associated with at least a portion of the vector embeddings assigned to the at least one cluster; or
a traffic volume associated with the vector embeddings assigned to the at least one cluster.

10. The method of claim 1, wherein the network operational data comprises:
network traffic data;
call detail record data;
at least one record of at least one customer interaction with at least one of: a customer service representative, a salesperson, an interactive voice response system, an online automated ordering system, or an online subscriber account system; or
network element status information.

11. The method of claim 1, wherein the at least one remedial action comprises generating a notification to at least one of:
an endpoint device associated with a user of the communication network;
a user account associated with the communication network; or
an automated system within the communication network.

12. The method of claim 1, wherein the at least one remedial action comprises:
blocking network traffic in the communication network;
re-routing the network traffic in the communication network;
assigning the network traffic to a particular class in the communication network; or
reducing throughput of the network traffic in the communication network.

13. The method of claim 1, wherein the at least one remedial action comprises:
reconfiguring at least one aspect of a radio access network portion of the communication network;
instantiating a virtual network function;
activating the virtual network function; or
deactivating the virtual network function.

14. A non-transitory computer-readable medium storing instructions which, when executed by a processing system including at least one processor, cause the processing system to perform operations, the operations comprising:
generating a plurality of vector embeddings from a set of network operational data of a communication network;
applying a variational autoencoder to the plurality of vector embeddings to create a set of stratified samples of the plurality of vector embeddings, wherein the set of stratified samples comprises at least a first portion of the plurality of vector embeddings;
training a self-organizing map using the stratified samples of the plurality of vector embeddings to create a plurality of clusters;
applying the self-organizing map to at least a second portion of the plurality of vector embeddings to assign vector embeddings of the at least the second portion of the plurality of vector embeddings to respective clusters of the plurality of clusters;
identifying at least one characteristic associated with at least one cluster of the plurality of clusters; and
performing at least one remedial action in the communication network in response to the identifying of the at least one characteristic.

15. A method comprising:
generating, by a processing system including at least one processor, a plurality of vector embeddings from a set of network operational data of a communication network;
applying, by the processing system, a variational autoencoder to the plurality of vector embeddings to create a set of stratified samples of the plurality of vector embeddings, wherein the set of stratified samples comprises at least a first portion of the plurality of vector embeddings;
training, by the processing system, a self-organizing map using the stratified samples of the plurality of vector embeddings to create a plurality of clusters;
generating, by the processing system, at least a first vector embedding from network operational data associated with at least a first entity;
applying, by the processing system, the at least the first vector embedding as an input to the self-organizing map to assign the at least the first vector embedding to a first cluster of the plurality of clusters; and
performing, by the processing system, at least one remedial action in the communication network in response to the at least the first vector embedding being assigned to the first cluster.

16. The method of claim 15, wherein the generating of the plurality of vector embeddings comprise generating the plurality of vector embeddings via an embedding model.

17. The method of claim 16, wherein the generating of the plurality of vector embeddings comprises:
creating, via generative model, generative text synopses for network operational data of the set of network operational data; and
applying the generative text synopses as inputs to the embedding model to obtain the plurality of vector embeddings as outputs of the embedding model.

18. The method of claim 15, wherein the self-organizing map is trained in accordance with a tree of parzens optimizer.

19. The method of claim 15, wherein the at least one remedial action is based on at least one characteristic of the first cluster, wherein the at least one characteristic comprises:
a category of the first cluster;
a number of vector embeddings assigned to the first cluster;
a geographic location associated with at least a portion of the vector embeddings assigned to the first cluster; or
a traffic volume associated with the vector embeddings assigned to the first cluster.

20. The method of claim 15, wherein the network operational data comprises:
network traffic data;
call detail record data;
at least one record of at least one customer interaction with at least one of: a customer service representative, a salesperson, an interactive voice response system, an online automated ordering system, or an online subscriber account system; or
network element status information.
